(19) United States
(12) Patent Application Publication
(10) Pub. No.: US 2016/0103353 A1
(43) Pub. Date: Apr. 14, 2016

(54) LIQUID-CRYSTAL DISPLAY DEVICE

(71) Applicant: LG DISPLAY CO., LTD., Seoul (KR)

(72) Inventor: HyungSeok KIM, Incheon (KR)

(73) Assignee: LG DISPLAY CO., LTD., Seoul (KR)

(21) Appl. No.: 14/882,040

(22) Filed: Oct. 13, 2015

(30) Foreign Application Priority Data
Oct. 13, 2014 (KR) 10-2014-013754

(51) Int. Cl. G02F 1/1339; G02F 1/1368; G02F 1/1362; G02F 1/1335

(52) U.S. Cl. CPC G02F 1/13394; G02F 1/133512; G02F 1/133514; G02F 1/1368; G02F 1/136286; G02F 2001/133357

(57) ABSTRACT

Discussed herein is a liquid-crystal display (LCD) device. In one example, the LCD device includes a substrate having a plurality of sub-pixel areas and a black matrix area. The LCD device further includes a black matrix, color filters to cover the side portions of black matrix, and a planarization layer. A plurality of column spacers are disposed on the planarization layer at locations corresponding to locations where the black matrix are disposed. The black matrix is in direct contact with the planarization layer at locations where the plurality of column spacers is disposed. Accordingly, the color filters do not overlap one another at locations where the column spacers are formed. As a result, a difference between heights of the plurality of column spacers can be maintained within a target range, and the durability of the LCD device can be improved.

### CROSS-REFERENCE TO RELATED APPLICATIONS

This application claims the priority of Korean Patent Application No. 10-2014-0137540 filed on Oct. 13, 2014, in the Korean Intellectual Property Office, the disclosure of which is incorporated herein by reference.

### BACKGROUND OF THE INVENTION

1. Technical Field

The present disclosure relates to a Liquid Crystal Display (LCD) device, and more specifically to an LCD device with improved durability by enhancing uniformity with respect to a difference in height between the top surface of a push column spacer and the top surface of a cell-gap spacer.

2. Description of the Related Art

Liquid crystal displays are displays that include a liquid crystal layer. Liquid crystal displays are driven by adjusting the transmittance of light from a light source such as a backlight unit. Recently, a demand for the liquid crystal displays with high resolution and low power consumption is increasing.

FIGS. 1A and 1B are schematic cross-sectional views for illustrating an LCD device according to a related art. Referring to FIG. 1A, in an existing LCD device 100, a black matrix 120 for preventing color mixing among sub-pixels, and color filters 130 (130R, 130G and 130B) are disposed on a substrate 110. The color filters 130 overlap one another on the black matrix 120. A planarization layer 140 is formed on the color filters 130. A cell-gap column spacer 150b and a push column spacer 150a are disposed on the planarization layer 140.

As shown in FIG. 1A, the top surface of the cell-gap column spacer 150b is at a higher level than the top surface of the push column spacer 150a. If the difference Δd1 between the distance d2 from the substrate 110 to the top surface of the cell-gap column spacer 150 and the distance d1 from the substrate 110 to the top surface of the push column spacer 150a deviates from a target range, various problems may occur.

For example, if the difference Δd1 is larger than the target range, a force imparted on the cell-gap column spacer 150b when the LCD device 100 is pressed may not be delivered to the push column spacer 150a. When this happens, a liquid-crystal alignment layer positioned corresponding to the cell-gap column spacer 150b may be damaged by the force imparted by the cell-gap column spacer 150b. If the liquid-crystal alignment layer is damaged, spots may occur on the LCD device 100.

On the other hand, if the difference Δd1 is smaller than the target range, when the LCD device 100 is pressed at a certain location, such causes liquid crystal spacing to be affected and can result in the number of liquid crystals at that location to increase relatively. Accordingly, such can cause the concentration of liquid crystals to become different locally. If the concentration of liquid crystals is different locally, light leakage may occur or light transmissivity may be difficult to control.

Accordingly, in terms of the durability of the LCD device 100, it is important to maintain the difference Δd1 between the distance d2 from the substrate 110 to the top surface of the cell-gap column spacer 150 and the distance d1 from the substrate 110 to the top surface of the push column spacer 150a to be within a certain range. In the existing LCD device 100, however, the cell-gap column spacer 150b and the push column spacer 150a are disposed on the color filters 130 overlapping one another. Thus, the uniformity on the difference Δd1 is not good enough because there may be a process margin in forming the color filters 130 and the thickness of the color filters overlapping one another may differ.

Referring to FIG. 1B, the red color filter 130R′ and the green color filter 130G′ do not overlap each other because of a process error, although they were designed to overlap each other on the black matrix 120 as shown in FIG. 1A. The green color filter 130G′ and the blue color filter 130B′, on the other hand, properly overlap each other as per the intended design. Accordingly, even though the planarization layer 140 is formed on the color filters 130′, there exists a step difference on the planarization layer 140 depending on whether the color filters properly overlap each other or not. In FIG. 1B, the planarization layer 140 is shown to have a depressed portion between the red color filter 130R′ and the green color filter 130G′ and a slightly protruding portion between the green color filter 130G′ and the blue color filter 130B′. The push column spacer 150a is formed between the red color filter 130R′ and the green color filter 130G′. The cell-gap column spacer 150b is formed between the green color filter 130R′ and the red color filter 130G′. Accordingly, in FIG. 1B, the planarization layer 140 fails to completely planarize the region above the color filters 130′ and has a step difference. As a result, even though the cell-gap spacer 150b and the push column spacer 150a have the same height as those of FIG. 1A, the difference Δd2 of FIG. 1B is different from the difference Δd1 of FIG. 1A. The difference Δd2 may deviate from the target range of the difference. If the difference deviates from the target range, the durability of the LCD device 100 may be lowered, as discussed earlier.

### SUMMARY OF THE INVENTION

In view of the above, an object of the present disclosure is to provide an LCD device having a novel structure capable of maintaining a difference between a distance from a substrate to a cell-gap spacer and a distance from the substrate to a push column spacer to be within a target range.

Another object of the present disclosure is to provide an LCD device capable of minimizing deviations in difference between a distance from a substrate to a cell-gap spacer and a distance from the substrate to a push column spacer within a target range, while maintaining the thickness of an LCD device and preventing color mixing among sub-pixels.

It should be noted that objects of the present disclosure are not limited to the above-described objects, and other objects of the present disclosure will be apparent to those skilled in the art from the following descriptions.

According to an aspect of the present disclosure, there is provided an LCD device, including a substrate having a plurality of sub-pixel areas and a black matrix area surrounding the plurality of sub-pixel areas. In addition, the LCD device includes a black matrix disposed in the black matrix area, color filters disposed in the plurality of sub-pixel areas to cover the side portions of black matrix, and a planarization layer formed over the black matrix and the color filter. A plurality of column spacers are disposed on the planarization layer at locations corresponding to where the black matrix is disposed. A part of the black matrix corresponding to a plurality of column spacers is in direct contact with the planarization layer. Accordingly, as a part of the black matrix corresponding to a plurality of column spacers is in direct contact with the planarization layer, the color filters do not overlap with locations where the column spacers are formed. As a result, a difference between heights of the plurality of column spacers can be maintained within a target range, and the durability of the LCD device can be improved when pressed.

The plurality of column spacers may include a cell-gap column spacer and a push column spacer.

A difference between a distance from the substrate to a top surface of the cell-gap column spacer and a distance from the substrate to a top surface of the push column spacer may be constant

A difference between a distance from the substrate to a top surface of the cell-gap column spacer and a distance from the substrate to a top surface of the push column spacer may be between 3,000 Å and 10,000 Å.

A difference between a distance from the substrate to a top surface of the cell-gap column spacer and a distance from the substrate to a top surface of the push column spacer may lie within an error margin of ±200 Å from a predetermined value.

A width of a location where the black matrix comes in direct contact with the planarization layer may be larger than a diameter of the plurality of column spacers.

A width of a location where the black matrix is in direct contact with the planarization layer may be equal to or larger than half a width of the black matrix.

A diameter of the plurality of column spacers may be larger than a width of the black matrix.

The LCD device may further include: an additional planarization layer disposed on the planarization layer, and the plurality of spacers may be disposed on the additional planarization layer.

According to an aspect of the present disclosure, there is provided an LCD device, including a first substrate on which a data line and a scan line intersecting the data line are disposed. The LCD device includes a second substrate facing the first substrate, a black matrix disposed on the second substrate at locations corresponding to where the data line and the scan line are disposed, a plurality of color filters covering side portions of the black matrix, and a planarization layer disposed over the black matrix and the plurality of color filters. A plurality of spacers are disposed on the planarization layer at an intersection of the data line and the scan line. Here, the black matrix is in direct contact with the planarization layer at the intersection of the data line and the scan line. Accordingly, as the black matrix is in direct contact with the planarization layer at the intersection of the data line and the scan line, deviations in difference between heights of the cell-gap column spacer and the push column spacer can be reduced.

The plurality of color filters may overlap one another on apart of the black matrix at a location corresponding to a location where the data line is disposed.

The plurality of spacers may include a cell-gap column spacer and a push column spacer. Further, a difference between a distance from the second substrate to a top surface of the cell-gap column spacer and a distance from the second substrate to a top surface of the push column spacer is maintained constant.

The plurality of color filters may include a red color filter, a green color filter and a blue color filter, and the plurality of spacers may be disposed adjacent to the blue color filter.

According to an aspect of the present disclosure, there is provided an liquid crystal display (LCD) device. The LCD device comprises a thin film transistor array and a color filter array including a black matrix, color filters, a cell-gap spacer and a push spacer color. The color filters on the black matrix, located below the cell-gap spacer and the push spacer, are deposited not to overlap with each other, thereby minimizing difference in height between the cell-gap spacer and the push spacer.

A height of the cell-gap spacer may be higher than a height of the push spacer.

A diameter of the cell-gap spacer may be lower than a line width of the black matrix.

A diameter of the push spacer may be higher than a line width of the black matrix.

The thin film transistor array may further comprise a scan line and a data line, and the cell-gap spacer and the push spacer may be deposited at a location where the scan line and the data line intersect.

The color filter array may further comprise a planarization layer below the cell-gap spacer and the push spacer, and the planarization layer may be in a direct contact with the black matrix at a location where the cell-gap spacer and the push spacer are located.

The color filters may be overlapped with each other on the black matrix in regions other than regions where the cell-gap spacer and the push spacers are deposited.

Particulars in the exemplary embodiments of the present disclosure will be described in the detail description with reference to the accompanying drawings.

According to embodiments of the present disclosure, the layers disposed below a cell-gap spacer and a push column spacer are minimized, so that an LCD device with reduced deviations in difference between heights of the cell-gap column spacer and the push column spacer can be provided.

In addition, an LCD device with improved durability can be provided in which the flatness of the planarization layer is improved without increasing the thickness of the LCD device, thereby maintaining the cell gap constant.

It should be noted that effects of the present disclosure are not limited to those described above and other effects of the present disclosure will be apparent to those skilled in the art from the following descriptions.

### BRIEF DESCRIPTION OF THE DRAWINGS

The above and other aspects, features and other advantages of the present disclosure will be more clearly understood from the following detailed description taken in conjunction with the accompanying drawings, in which:

FIGS. 1A and 1B are schematic cross-sectional views for illustrating an LCD device according to a related art;

FIG. 2 is a schematic plan view of an LCD device according to an exemplary embodiment of the present invention;

FIG. 3 is a cross-sectional view of the LCD device, taken along line III-III′ of FIG. 2.

FIG. 4 is a schematic cross-sectional view of the LCD device, taken along line IV-IV′ of FIG. 2;

FIG. 5 is a schematic plan view of an LCD device according to another exemplary embodiment of the present invention;

FIG. 6 is a schematically plan view of an LCD device according to still another exemplary embodiment of the present invention; and

FIG. 7 is a schematic cross-sectional view of the LCD device, taken along line VII-VII′ of FIG. 6.

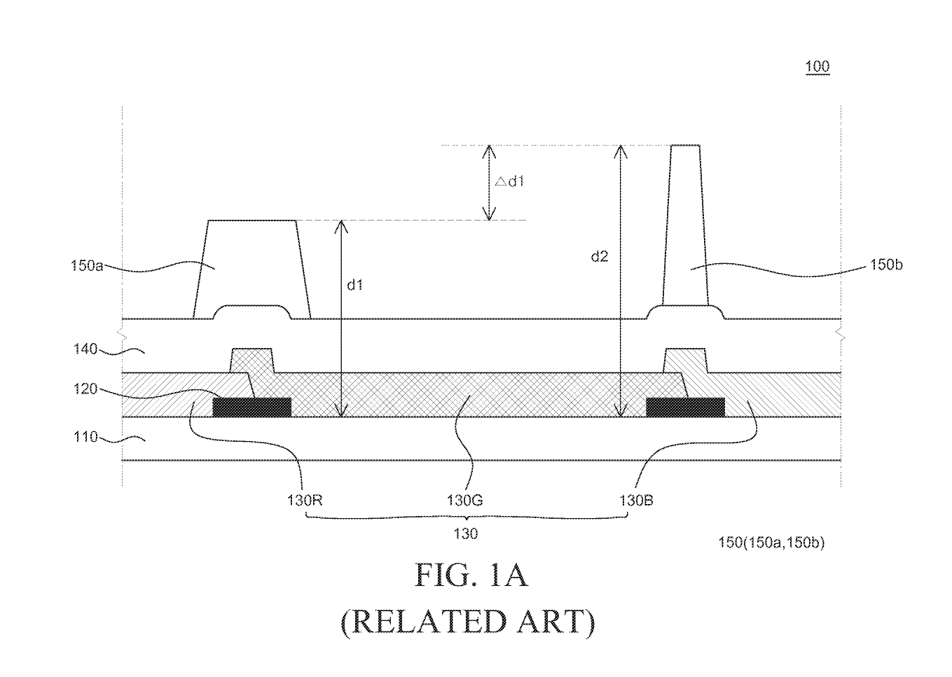

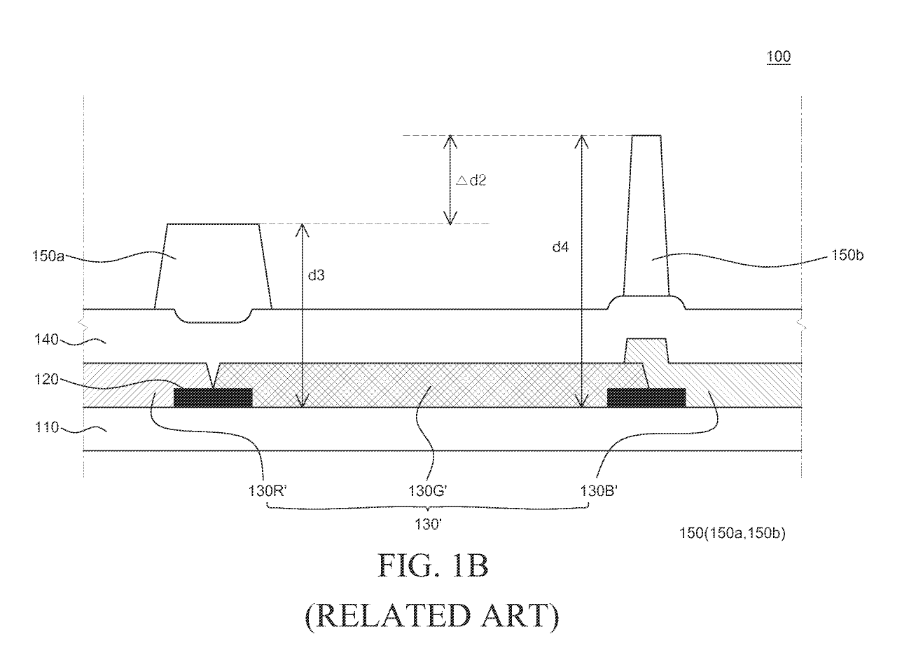

### DETAILED DESCRIPTION OF THE PREFERRED EMBODIMENTS

Advantages and features of the present disclosure and methods to achieve them will become apparent from the descriptions of exemplary embodiments herein below with reference to the accompanying drawings. However, the present disclosure is not limited to exemplary embodiments disclosed herein but may be implemented in various different ways. The exemplary embodiments are provided for making the disclosure of the present disclosure thorough and for fully conveying the scope of the present disclosure to those skilled in the art. It is to be noted that the scope of the present disclosure is defined only by the claims.

As used herein, a phrase “an element A on an element B” refers to that the element A may be disposed directly on the element B and/or the element A may be disposed indirectly on the element B via another element C.

Although terms such as first, second, etc. are used to distinguish arbitrarily between the elements such terms describe and these terms are not necessarily intended to indicate temporal or other prioritization of such elements. These terms are used to merely distinguish one element from another. Accordingly, as used herein, a first element may be a second element within the technical scope of the present invention.

Like reference numerals denote like elements throughout the descriptions.

The drawings are not to scale and the relative dimensions of various elements in the drawings are depicted schematically and not necessarily to scale.

Features of various exemplary embodiments of the present disclosure may be combined partially or totally. As will be clearly appreciated by those skilled in the art, technically various interactions and operations are possible. Various exemplary embodiments can be practiced individually or in combination.

Hereinafter, exemplary embodiments of the present disclosure will be described in detail with reference to the accompanying drawings.

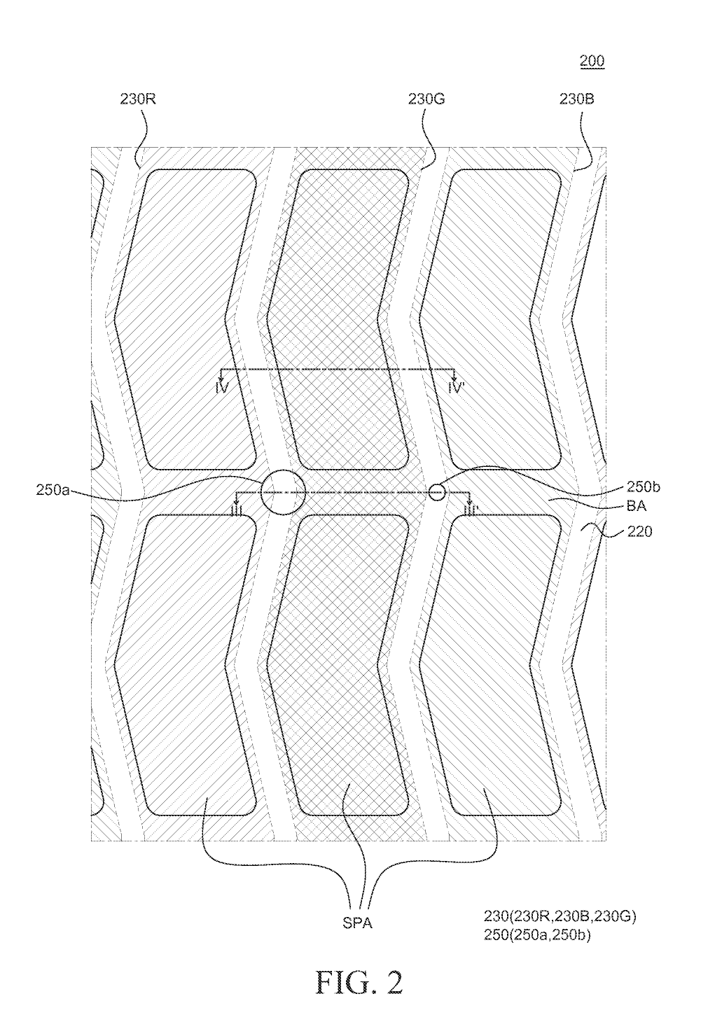

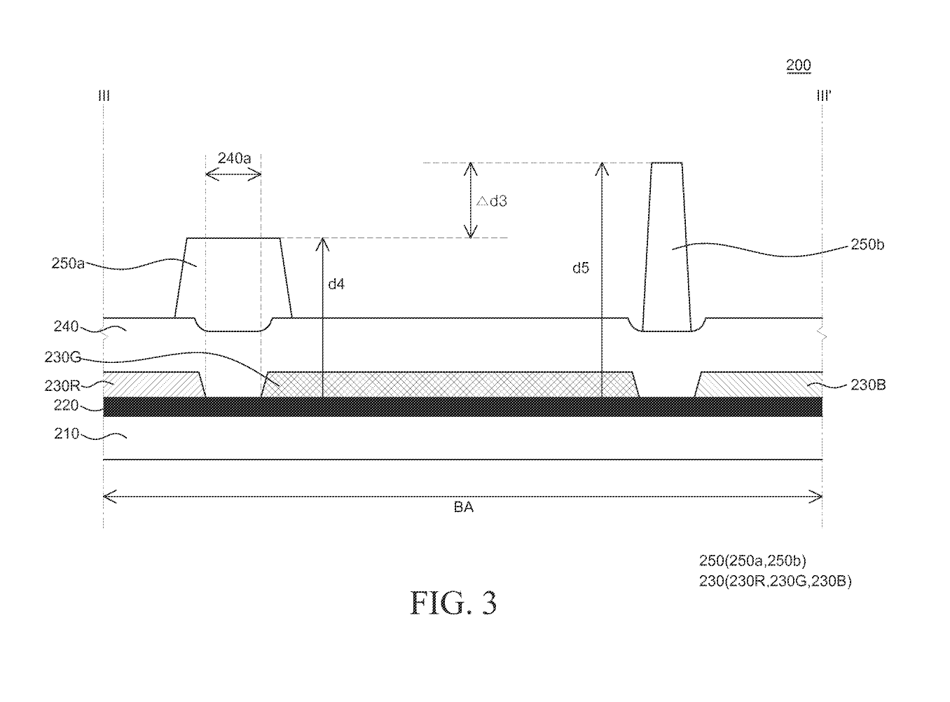

FIG. 2 is a schematic plan view of an LCD device according to an exemplary embodiment of the present disclosure. FIG. 3 is a cross-sectional view of the LCD device, taken along line III-III′ of FIG. 2. For convenience of illustration, FIGS. 2 and 3 only show a black matrix 220, color filters 230 and a plurality of column spacers 250 disposed on a substrate 210 of an LCD device 200. However, all the components of the LCD device in this and all other embodiments are operatively coupled and configured.

Referring to FIG. 2, the substrate 210 has a plurality of sub-pixel areas (SPAs), and a black matrix area (BA) surrounding the plurality of sub-pixel areas (SPAs). Each of the sub-pixel areas SPAs displays one of red, green and blue colors. In the black matrix areas BAs, no image is displayed and a black matrix 220 is disposed. That is, in FIG. 2, the black matrix area BA corresponds to the area where the black matrix 220 is disposed.

The black matrix 220 absorbs light in order to prevent light from exiting from the black matrix area BA. The black matrix 220 reduces color mixing among sub-pixels. In addition, the black matrix 220 is disposed such that it overlaps with opaque or reflective layers such as lines.

The color filters 230 allow only some of the wavelengths of transmitted light to pass therethrough to reproduce colors. Accordingly, the color filters 230 are disposed above the substrate 210 such that they cover the plurality of sub-pixel areas SPAs to reproduce the colors of the sub-pixels. In addition, the color filters 230 cover side portions of the black matrix 220. As the color filters 230 cover the side portions of the black matrix 220, all of the light from the plurality of sub-pixel areas SPAs can pass through the color filters 203 to reproduce a desired color.

Referring to FIG. 2, the color filters 230 are disposed in the substantially vertical direction with respect to the sub-pixel areas SPAs. Accordingly, the sub-pixel areas SPAs in the same column display the light of the same color. The sub-pixel areas SPAs in the same row display light of red, green and blue colors, respectively.

The color filters 230 may have a thickness between 20,000 Å and 35,000 Å, such as between 28,000 Å and 33,000 Å. The color filters 230 are disposed on the black matrix 220 such that they do not overlap one another. For example, as shown in FIGS. 2 and 3, a red color filter 230R does not overlap a green color filter 230G, and the green color filter 230G does not overlap a blue color filter 230B. Accordingly, the black matrix 220 may have an exposed area where no color filter 230 is disposed.

A planarization layer 240 is disposed over the color filters 230 and the black matrix 220. The planarization layer 240 can be formed on the entire surface of the substrate 210, and planarizes the region above the black matrix 220 and the color filters 230. The planarization layer 240 is disposed on the color filters 230 at locations where the color filters 230 are formed, and is disposed to be in direct contact with the black matrix 220 at locations 240a where no color filter is formed.

In order to reduce the thickness of the LCD device 200, the planarization layer 240 should have minimal thickness while planarizing the region above the color filters 230. For example, the planarization layer 240 may have a thickness between 10,000 Å and 30,000 Å. Since the color filters 230 have a thickness equal to or greater than 20,000 Å, the thickness of a portion where a color filter overlaps another color filter may be equal to or greater than 40,000 Å. If the thickness is equal to or greater than 40,000 Å, the planarization layer 240 having only minimal thickness cannot completely planarize the region above the color filters 230 and the black matrix 220. In the LCD device 200 according to the exemplary embodiment of the present disclosure, however, the color filters 230 do not overlap one another on the black matrix 220, and the black matrix 220 is in direct contact with the planarization layer 240. Accordingly, the color filters 230 do not overlap one another even if there is a process error in forming the color filters 230. As the color filters 230 do not overlap one another, the planarization layer 240 may have a depressed location 240a below which the black matrix 220 is in direct contact with the planarization layer 240. However, despite such a depressed portion, the distance from the substrate 210 to the top surface of the planarization layer 240 can be generally maintained within an expected range even if there is a process error.

The plurality of column spacers 250 is disposed on the planarization layer 240. The plurality of spacers 250 includes a cell-gap column spacer 250b and a push column spacer 250a. The cell-gap column spacer 250b refers to a column-like spacer to keep a liquid-crystal cell gap at certain thickness between the substrate 210 and a substrate that faces the substrate 210 with thin-film transistors disposed thereon. The push column spacer 250a is to disperse a force imparted on the cell-gap column spacer 250b to avoid the cell-gap from being overly reduced when the substrate 210 is pressed.

The cell-gap spacer 250b is formed to be in contact with elements facing the substrate. For example, the cell gap column spacer 250 is in contact with a liquid-crystal alignment film when the substrate 210 is coupled with the facing substrate.

The plurality of column spacers 250 has a cylinder shape. The plurality of column spacers 250 has a trapezoid shape for which the width thereof increases going down from the top surface to the bottom surface. Accordingly, each of the plurality of column spacers 250 has sloped side surfaces. However, the shape of the plurality of column spacers 250 is not limited thereto, but may have a shape of a square pillar with a square cross section.

It is to be noted that the cell-gap column spacer 250b and the push column spacer 250a of the plurality of column spacers 250 have different diameters and heights. For example, the height of the push column spacer 250a may be lower than that of the cell-gap column spacer 250b. Accordingly, while the cell-gap column spacer 250b is in contact with a liquid-crystal alignment film of the facing substrate, while the top surface of the push column spacer 250a may not be in contact with the liquid-crystal alignment film in the liquid-crystal layer.

The plurality of column spacers 250 is disposed on the planarization layer 240 at locations corresponding to where the black matrix 220 is formed. In addition, the locations where the plurality of column spacers 250 is disposed correspond to 240a where the black matrix 220 is in direct contact with the planarization layer 240. Referring to FIG. 3, the push column spacer 250a is disposed above a location 240a where the black matrix 220 is in direct contact with the planarization layer 240. A part of the outer portion of the push column spacer 250a may be formed above the color filters 230. In addition, the cell-gap column spacer 250b is disposed in the region that is substantially equal to or smaller than the location where the black matrix 220 and the planarization layer 240 are in direct contact with each other.

In the LCD device 200 according to the exemplary embodiment of the present disclosure, preferably, it is important to have a constant flatness of the planarization layer 240, i.e., having the distance from the substrate 210 to the planarization layer 240 equal. In an existing LCD device, color filters are disposed such that they overlap one another. This is to ensure that the color filters cover the sub-pixels even if there is a process error in forming the color filters. In such an existing LCD device with the color filters overlapping one another, however, a difference between the distance from the substrate to the cell-gap spacer and the distance from the substrate to the push column spacer was not considered. Accordingly, if there is a process error in forming the color filters, a difference between the distance from the substrate to the cell-gap spacer and the distance from the substrate to the push column spacer frequently deviates from a target range. In contrast, in the LCD device 200 according to the exemplary embodiment of the present disclosure, the height of the top surface of the planarization layer 240 on which the plurality of column spacers 250 is disposed is relatively even, and thus the difference in height of the top surface of the plurality of column spacers 250 can be controlled within a target range. In the following descriptions, the height of a top surface of an element refers to a distance from the substrate 210 to the top surface of the element.

Referring to FIG. 3, a difference Δd3 between a distance d4 from the substrate 210 to the top surface of the push column spacer 250a and a distance d5 from the substrate 210 to the top surface of the cell-gap column spacer 250b is constant. For example, the difference Δd3 between a distance d5 from the substrate 210 to the top surface of the cell-gap column spacer 250b and a distance d4 from the substrate 210 to the top surface of the push column spacer 250a may range from 3,000 Å to 7,000 Å. If the difference Δd3 in distance is maintained within the target range, spots occurring when the LCD device 200 is pressed is reduced, so that the durability of the LCD device 200 can be improved. In some embodiments, the difference Δd3 between the distance d5 from the substrate 210 to the top surface of the cell-gap column spacer 250b and the distance d4 from the substrate 210 to the top surface of the push column spacer 250a may be approximately 5,000 Å.

In addition, the difference Δd3 between the distance d5 from the substrate 210 to the top surface of the cell-gap column spacer 250b and the distance d4 from the substrate 210 to the top surface of the push column spacer 250a may lie within an error margin of ±200 Å from a predetermined value.

For example, if the difference Δd3 between the distance d5 from the substrate 210 to the top surface of the cell-gap column spacer 250b and the distance d4 from the substrate 210 to the top surface of the push column spacer 250a is 5,000 Å, the difference Δd3 is maintained within the range from 4,800 Å to 5,200 Å. If the difference Δd3 is smaller than 4,800 Å, when the LCD device 200 is pressed, a pressed space is reduced and the number of liquid crystals in the same space increases relatively. That is, the concentration of liquid crystals may become different locally. If the concentration of liquid crystals is different locally, light leakage may occur or light transmissivity may be difficult to control. If the difference Δd3 is larger than 5,200 Å, a force imparted on the cell-gap column spacer 250b when the LCD device 200 is pressed may not be dispersed to the push column spacer 250a. Accordingly, the cell-gap column spacer 250b may damage the liquid-crystal alignment layer. If the liquid-crystal alignment layer is damaged, spots may occur on the LCD device 200. In the LCD device 200 according to the exemplary embodiment of the present disclosure, the difference Δd3 between the distance d5 from the substrate 210 to the top surface of the cell-gap column spacer 250b and the distance d4 from the substrate 210 to the top surface of the push column spacer 250a lies within an error margin of ±200 Å from a predetermined value. Thus, damage to the LCD device 200 when the LCD device 200 is pressed can be minimized. As a result, the durability of the LCD device 200 can be improved.

Although not shown in FIGS. 2 and 3, the LCD device 200 may include a plurality of lines, thin-film transistors, pixel electrodes, a common electrode, a liquid-crystal alignment layer, and a liquid-crystal layer, in addition to the elements shown in FIGS. 2 and 3. In addition, the LCD device 200 may be an IPS (In-Plane Switching) LCD device 200 in which pixel electrodes are disposed above a common electrode. Alternatively, the LCD device 200 may be an IPS LCD device 200 in which a common electrode is disposed above pixel electrodes or a common electrode and pixel electrodes are disposed in the same layer.

In addition, electrodes of the LCD device 200 may have a rectangular shape, a straight line shape, or a zigzag shape having at least one turn. That is, the LCD device 200 according to the exemplary embodiment of the present disclosure is not limited by particular shapes of electrodes, color filters, black matrix, etc. employed in an IPS LCD device, but can be implemented adaptively depending on elements having a variety of shapes.

The planarization layer 240 may completely planarize the region above the color filter 230 and the black matrix 220 depending on the material and thickness of the planarization layer 240. Accordingly, the plurality of column spacers 250 can be formed at a desired height, and the difference Δd3 between the distance d5 from the substrate 210 to the top surface of the cell-gap column spacer 250b and the distance d4 from the substrate 250 to the top surface of the push column spacer 250a can be uniformly maintained.

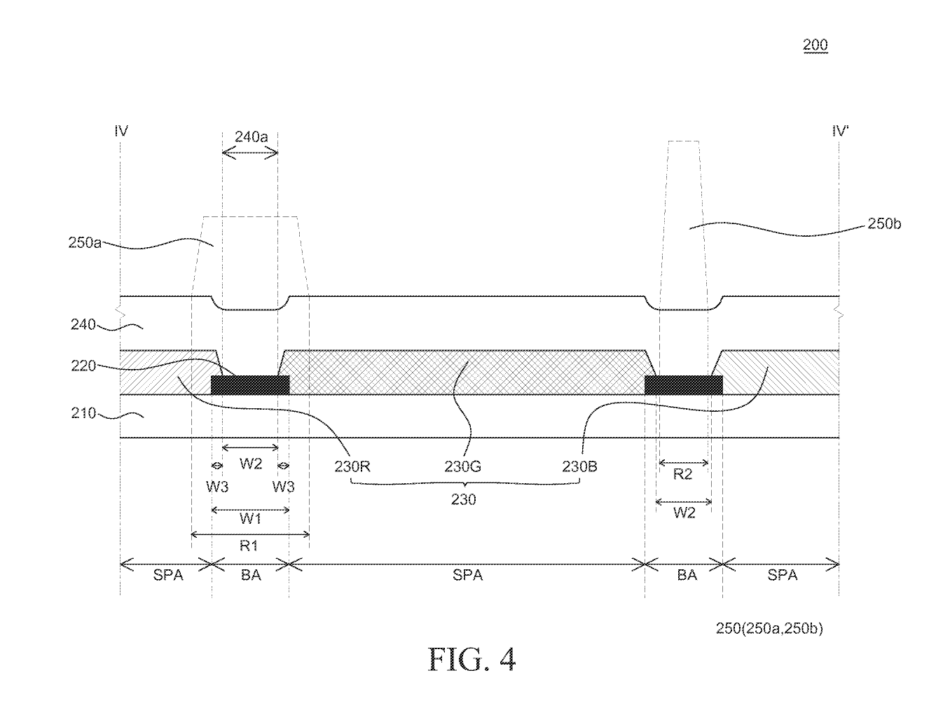

Hereinafter, the location 240a where the black matrix 220 is in direct contact with the planarization layer 240, and widths of the plurality of column spacers 250 in the LCD device 200 will be described in more detail with reference to FIG. 4. FIG. 4 is a schematic cross-sectional view of the LCD device 200, taken along line IV-IV′ of FIG. 2. A cross section of the black matrix 220 and the color filters 230 extended in the vertical direction of the LCD device 200 is shown, taken along line IV-IV′ of FIG. 2. In the cross sectional view, sub-pixel areas SPAs and a black matrix area BA are disposed alternately. In the structure of an existing LCD device in which color filters overlap one another or are disposed adjacent to one another, the color filters are disposed with respect to the narrowest portion of the black matrix such that they overlap one another. That is, the area where the color filters are disposed is determined by taking into account the area where the black matrix is overlapped. The color filters 230 in the LCD device 200 according to the exemplary embodiment of the present disclosure are also disposed with respect to line IV-IV′ which is the narrowest portion of the black matrix 220. The relationship between diameters of the plurality of column spacers 250 and the width of the black matrix 220 will be described with reference to FIG. 4. In addition, the plurality of column spacers 250 is depicted with dashed lines in FIG. 4, assuming that the plurality of column spacers 250 shown in FIG. 3 is located in the cross-sectional view of FIG. 4.

In FIG. 4, a width W1 of the cross section of the black matrix 220 may be between 7 μm and 8 μm. The width W1 of the cross section of the black matrix 220 is the sum of a width W2 of the location 240a where the black matrix 220 is in contact with the planarization layer 240 and a width W3 of a location where the color filter 230 overlaps the black matrix 220. The width W2 of the location 240a where the black matrix 220 is in direct contact with the planarization layer 240 may be equal to or greater than half the width W1 of the black matrix 220. For example, the width W2 of the location 240a where the black matrix 220 is in contact with the planarization layer 240 may be 4 μm, and a width W3 of each of the locations where the color filter 230 overlaps the black matrix 220 may be 2 μm. Accordingly, a sufficient area for the planarization layer 240 on which the plurality of column spacers 250 is disposed is obtained, and the difference Δd3 between the distance d5 from the substrate 210 to the top surface of the cell-gap column spacer 250b and the distance d4 from the substrate 250 to the top surface of the push column spacer 250a can be maintained constant.

In addition, the width W2 of the location 240a where the black matrix 220 is in direct contact with the planarization layer 240 may be equal to or greater than the diameters of the plurality of column spacers 250. For example, a diameter R2 of the cell-gap column spacer 250b may be smaller than the width W2 of the location 240a where the black matrix 220 is in direct contact with the planarization layer 240. Since the cell-gap column spacer 250b is disposed at a location which is irrelevant to the thickness of the color filter 230, the distance d5 from the substrate 210 to the cell-gap column spacer 250b can lie within a target range.

In addition, the diameters R1 and R2 of the plurality of column spacers 250 may be larger than the width W1 of the black matrix 220. For example, the diameter R1 of the push column spacer 250a may be larger than the width W1 of the black matrix 220. That is, the push column spacer 250a may be formed above the location 240a where the black matrix 220 is in direct contact with the planarization layer 240, the location where the color filter 230 is formed on the black matrix 220, and a location where only the color filter 230 is formed. The center of the push column spacer 250a may be disposed above the location 240a where the black matrix 220 is in direct contact with the planarization layer 240. Since the push column spacer 250a is formed on a flat portion, the distance d4 from the substrate 210 to the push column spacer 250a can be maintained within the target range.

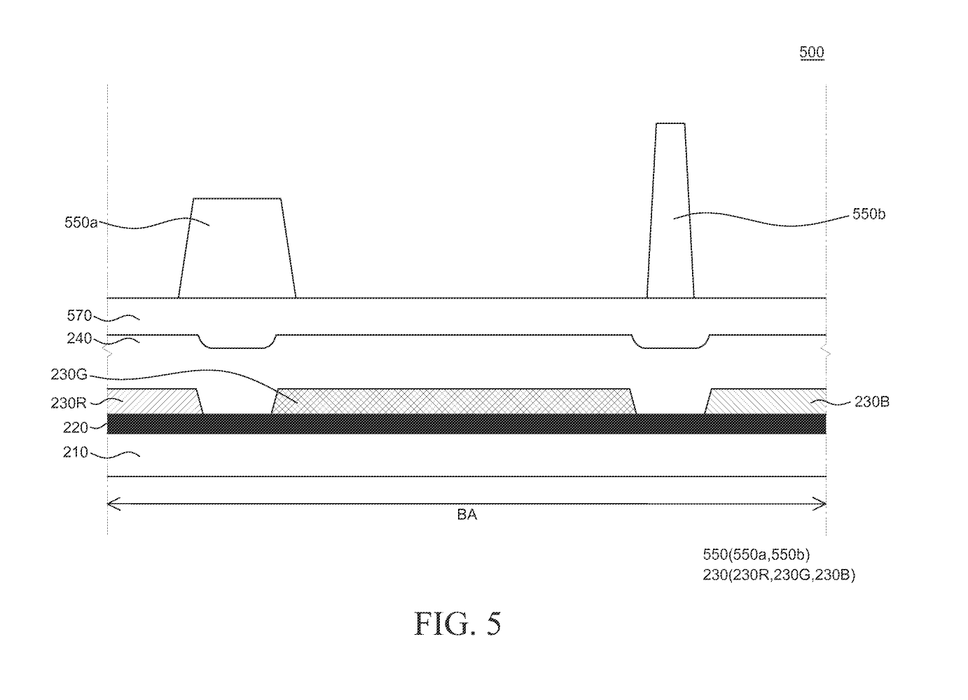

FIG. 5 is a schematic plan view of an LCD device according to another exemplary embodiment of the present disclosure. Elements of the LCD device 500 of FIG. 4 that are substantially identical to those of the LCD device 200 shown in FIG. 3 will not be described again or will be discussed briefly.

An additional planarization layer 570 is disposed on the planarization layer 240. The additional planarization layer 570 is formed on the planarization layer 240 required to have minimal thickness, and provides a more even surface for the plurality of column spacers 550. The additional planarization layer 570 may be made of the same material as the planarization layer 240. Alternatively, the additional planarization layer 570 may be made of a material having high adhesion with the plurality of column spacers 550 for enhanced adhesion therebetween. The additional planarization layer 570 may planarize a depressed portion in the planarization layer 240 possibly created by a step difference of the color filters 230.

The plurality of column spacers 550 is disposed on the additional planarization layer 570. A cell-gap column spacer 550b and a push column spacer 550a are disposed on the additional planarization layer 570 which provides a more even surface. Accordingly, a difference between a distance from the substrate 210 to the cell-gap column spacer 550b and a distance from the substrate 210 to the push column spacer 550a can be uniformly maintained.

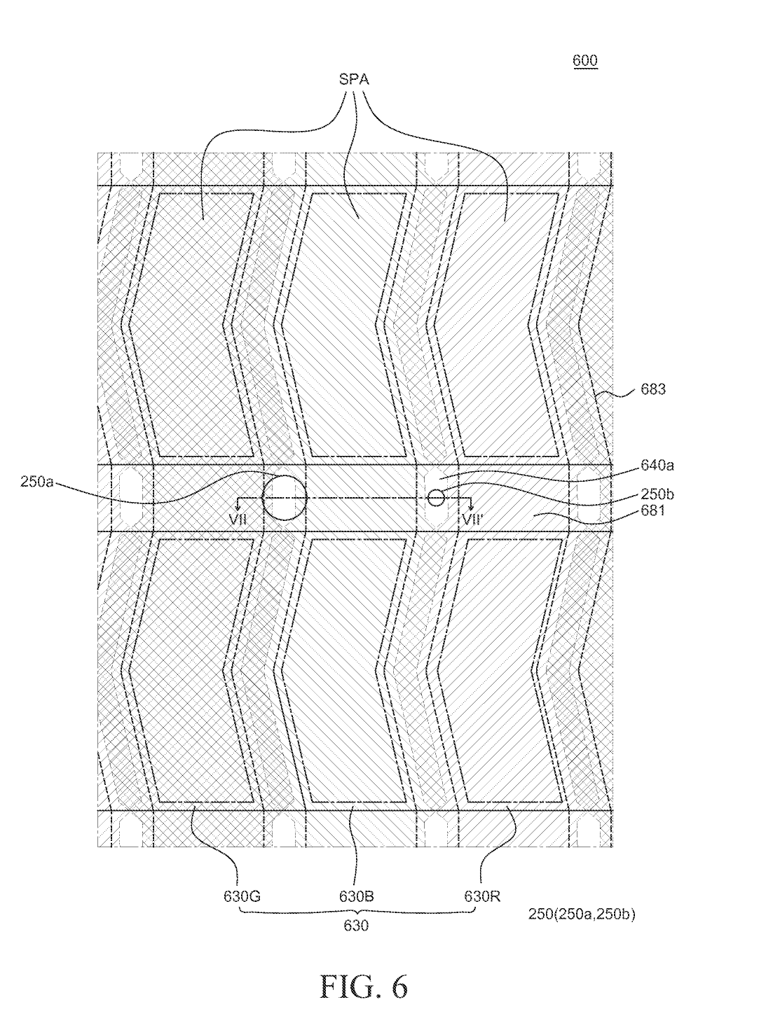

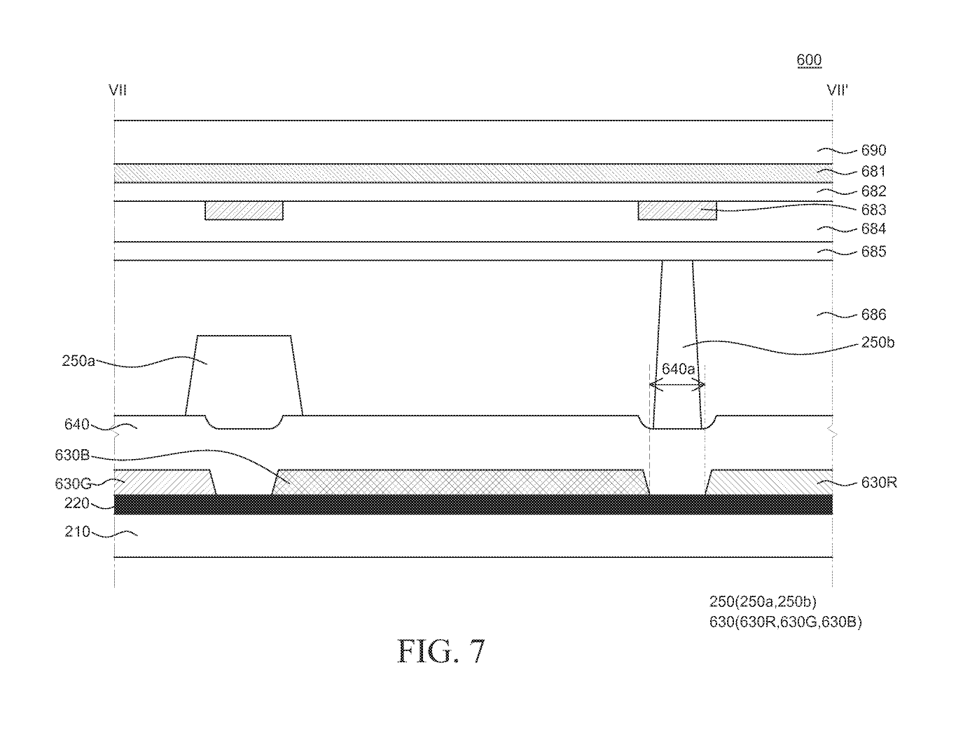

FIG. 6 is a schematically plan view of an LCD device according to still another exemplary embodiment of the present disclosure. FIG. 7 is a schematic cross-sectional view of the LCD device, taken along line VII-VII′ of FIG. 6. For convenience of illustration, FIG. 6 only shows scan lines 681 and data lines 683 formed and facing substrate 690 with thin-film transistors disposed thereon, and color filters 230 disposed on the substrate 210 of the LCD device. That is, instead of the black matrix 220 shown in FIG. 2, the data lines 683 and the scan lines 681 are shown in FIG. 6 which are disposed at the locations substantially corresponding to where the black matrix 220 is disposed.

Referring to FIG. 7, the data lines 683 and the scan lines 681 are disposed under the facing substrate 690 such that they intersect each other. An insulation layer 682 is disposed between the data lines 683 and the scan lines 681. A thin-film transistor planarization layer 684 is formed under the data lines 683. A liquid-crystal alignment film 685 is disposed under the thin-film transistor planarization layer 684. A liquid-crystal layer 686 is formed between the liquid-crystal alignment film 685 and the substrate 210.

The black matrix 220 is disposed on the substrate 210. The black matrix 220 is disposed at the location corresponding to where the data lines 683 and the scan lines 681 are disposed. The color filters 630 are formed in the sub-pixel areas SPAs, a part of which covers side portions of the black matrix 220.

In the LCD device according to this exemplary embodiment of the present disclosure, the color filters 630 are disposed such that they overlap one another at some locations corresponding to where the data lines 683 are disposed. In FIG. 6, the area in which the color filters 630 overlap one another is indicated with cross hatching lines. The color filters 630 are not formed in areas where the plurality of column spacers 250 is disposed. That is, in the areas where the plurality of column spacers 250 is disposed, the black matrix 220 is in direct contact with the planarization layer 640. Accordingly, a difference in height between the top surfaces of the plurality of column spacers 250 can be maintained constant.

Each of the plurality of column spacers 250 can be disposed at an intersection of a data line 683 and a scan line 681. Accordingly, the black matrix 220 is in direct contact with the planarization layer 640 at the intersections of the data lines 683 and the scan lines 681. Since the intersections of the data lines 683 and the scan lines 681 are the farthest locations from the center of the sub-pixel areas SPAs in the area where the black matrix 220 is formed, even if the liquid-crystal alignment film 685 is damaged by the plurality of column spacers 250 when the LCD device 600 is pressed, it is possible to reduce spots occurring on the LCD device. In addition, the cell-gap column spacer 250b and the push column spacer 250a of the plurality of column spacers 250 are located on the same scan line 681 next to each other. Accordingly, the cell-gap column spacer 250b and the push column spacer 250a may be represented as a set.

The color filters 630 include a red color filter 630R, a green color filter 630G and a blue color filter 630B. The plurality of column spacers 250 may be disposed adjacent to the blue color filter 630B. The blue light emitted from a sub-pixel area SPA where the blue color filter 630B is disposed is less bright than light of other colors. Accordingly, even if the liquid-crystal alignment film 685 is damaged by the plurality of column spacers 250 when the LCD device 600 is pressed so that spots occur, such spots occurring when the liquid-crystal alignment film 685 in the blue sub-pixel areas SPAs is damaged may be less perceivable than those occurring when the liquid-crystal alignment film 685 in the green sub-pixel areas SPAs is damaged.

The elements below the facing substrate 690 may include thin film transistors and lines 681, 683. Those elements may forma thin film transistor array. The elements above the substrate 210 may black matrix 220, color filters 630, cell-gap spacer 250b and push spacer color 250a. Those elements may form a color filter array. The color filters 630 on the black matrix 220, located below the cell-gap spacer 250b and the push spacer 250a are deposited not to overlap with each other, thereby minimizing the difference in height between the cell-gap spacer and the push spacer

Thus far, exemplary embodiments of the present disclosure have been described in detail with reference to the accompanying drawings. However, the present disclosure is not limited to the exemplary embodiments, and modifications and variations can be made thereto without departing from the technical idea of the present disclosure. Accordingly, the exemplary embodiments described herein are merely illustrative and are not intended to limit the scope of the present disclosure. The technical idea of the present disclosure is not limited by the exemplary embodiments. Therefore, it should be understood that the above-described embodiments are not limiting but illustrative in all aspects. The scope of protection sought by the present disclosure is defined by the appended claims and all equivalents thereof are construed to be within the true scope of the present disclosure.

What is claimed is:

1. A liquid crystal display (LCD) device, comprising:
a substrate having a plurality of sub-pixel areas and a black matrix area surrounding the plurality of sub-pixel areas;
a black matrix in the black matrix area;
a color filter in the plurality of sub-pixel areas and configured to cover side portions of the black matrix;
a planarization layer disposed over the black matrix and the color filter; and
a plurality of spacers on the planarization layer and located to correspond to the black matrix,
wherein the black matrix is in direct contact with the planarization layer at the locations where the plurality of spacers are disposed.

2. The LCD device of claim 1, wherein the plurality of spacers comprise a cell-gap spacer and a push spacer.

3. The LCD device of claim 2, wherein a difference between a distance from the substrate to a top surface of the cell-gap spacer and a distance from the substrate to a top surface of the push spacer is constant.

4. The LCD device of claim 3, wherein the difference between the distance from the substrate to the top surface of the cell-gap spacer and the distance from the substrate to the top surface of the push spacer is between approximately 3,000 Å and 10,000 Å.

5. The LCD device of claim 3, wherein the difference between the distance from the substrate to the top surface of the cell-gap spacer and the distance from the substrate to the top surface of the push spacer lies within an error margin of approximately ±200 Å from a predetermined difference.

6. The LCD device of claim 1, wherein a width of a location where the black matrix is in direct contact with the planarization layer is larger than a diameter of the plurality of spacers.

7. The LCD device of claim 1, wherein a width of a location where the black matrix is in direct contact with the planarization layer is equal to or larger than half of a width of the black matrix.

8. The LCD device of claim 1, wherein a diameter of the plurality of spacers is larger than a width of the black matrix.

9. The LCD device of claim 1, further comprising:
an additional planarization layer on the planarization layer,
wherein the plurality of spacers are disposed on the additional planarization layer.

10. A liquid-crystal display (LCD) device, comprising:
a first substrate on which a data line and a scan line intersecting the data line are disposed;
a second substrate facing the first substrate;
a black matrix on the second substrate at locations corresponding to locations where the data line and the scan line are disposed;
a plurality of color filters configured to cover side portions of the black matrix;
a planarization layer disposed over the black matrix and the plurality of color filters; and
a plurality of spacers, each spacer on the planarization layer at an intersection of the data line and the scan line,
wherein the black matrix is in direct contact with the planarization layer at the intersection of the data line and the scan line.

11. The LCD device of claim 10, wherein the plurality of color filters overlap one another on a part of the black matrix at a location corresponding to where the data line is disposed.

12. The LCD device of claim 10, wherein the plurality of spacers comprise a cell-gap spacer and a push spacer,
wherein a difference between a distance from the second substrate to a top surface of the cell-gap spacer and a distance from the second substrate to a top surface of the push spacer is constant.

13. The LCD device of claim 10, wherein the plurality of color filters comprise a red color filter, a green color filter and a blue color filter, and the plurality of spacers are disposed adjacent to the blue color filter.

14. A liquid crystal display (LCD) device, comprising:
a thin film transistor array; and
a color filter array including a black matrix, color filters, a cell-gap spacer and a push spacer color,
wherein the color filters on the black matrix, located below the cell-gap spacer and the push spacer, are deposited not to overlap with each other, thereby minimizing a difference in height between the cell-gap spacer and the push spacer.

15. The LCD device of claim 14, wherein a height of the cell-gap spacer is higher than a height of the push spacer.

16. The LCD device of claim 15, wherein a diameter of the cell-gap spacer is lower than a line width of the black matrix.

17. The LCD device of claim 15, wherein a diameter of the push spacer is higher than a line width of the black matrix.

18. The LCD device of claim 14, wherein the thin film transistor array further comprises a scan line and a data line, and the cell-gap spacer and the push spacer are deposited at a location where the scan line and the data line intersect.

19. The LCD device of claim 14, wherein the color filter array further comprises a planarization layer below the cell-gap spacer and the push spacer, and the planarization layer is in direct contact with the black matrix at a location where the cell-gap spacer and the push spacer are located.

20. The LCD device of claim 14, wherein the color filters are overlapped with each other on the black matrix in regions other than regions where the cell-gap spacer and the push spacers are deposited.
